(19) United States
(12) Patent Application Publication
(10) Pub. No.: US 2008/0232303 A1
(43) Pub. Date: Sep. 25, 2008

(54) IP mobile communication system and base station

(75) Inventors: Junichi Takahashi, Hamura-shi (JP); Takeshi Nagai, Tokorozawa-shi (JP); Tatsuya- Zettsu, Ome-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/725,809

(22) Filed: Mar. 20, 2007

(51) Int. Cl. H04Q 7/00

(52) U.S. Cl. 370/328

(57) ABSTRACT

When mobile communication exchange detects that SIP client has moved out of communication area of base station, the mobile communication exchange generates a BYE message, sends the generated BYE message to SIP client and ends a session.

### BACKGROUND OF THE INVENTION

1. Field of the Invention

The present invention relate to an IP mobile communication system executing communication through an IP network.

2. Description of the Related Art

A conventional IP mobile communication system based on 3GPP TS24.228 employs SIP (Session Initiation Protocol) as a call control protocol. In the IP mobile communication system employing the SIP as the call control protocol, when one of two terminals in communication with each other moves out of a communication area, the other terminal maintains a session although a radio link of the partner terminal is cut off, unless the other terminal detects disconnection of a session with the partner terminal in the session monitoring (for example, regular monitoring at an interval of some tens of seconds) based on the SIP protocol (for example, RFC4028, Session Times in the Session Initiation Protocol (SIP) (S. Donovan, Rosenberg, Sysco Systems, April 2005)).

In the conventional IP mobile communication system, when one of two terminals in communication with each other moves out of a communication area, the other terminal maintains a session although a radio link of the partner terminal is cut off.

### BRIEF SUMMARY OF THE INVENTION

The present invention has been accomplished to solve the above-described problems. The object of the present invention is to provide an IP mobile communication system capable of rapidly disconnecting a session and reducing the time to maintain an unnecessary session if one of two terminals in communication with each other moves out of a communication area.

To achieve this object, an aspect of the present invention is a base station connected to an exchange apparatus and connectable to a client terminal.

The base station comprises a detector configured to detect that the client terminal cannot make radio connection with the base station, and a notifying unit configured to transmit a disconnection request to the exchange apparatus if the detector detects that the client terminal cannot make radio connection with the base station.

Accordingly, the present invention can provide an IP mobile communication system and a base station capable of rapidly disconnecting a session and reducing the time to maintain an unnecessary session if one of two terminals in communication with each other moves out of a communication area.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an illustration showing a configuration of an IP mobile communication system according to an embodiment of the present invention;

FIG. 2 is a block diagram showing a configuration of an IP mobile radio terminal of the IP mobile communication system shown in FIG. 1;

FIG. 3 is a block diagram showing a configuration of a controlling unit of the IP mobile radio terminal shown in FIG. 2;

FIG. 4 is a block diagram showing a configuration of a mobile communication exchange of the IP mobile communication system shown in FIG. 1;

FIG. 5 is an illustration showing operations of the IP mobile communication system according to the present invention;

FIG. 6 is a sequence diagram showing operations of the IP mobile communication system according to the present invention;

FIG. 7 is an example of a BYE message sent from the mobile exchange shown in FIG. 1 to the IP mobile radio terminal;

FIG. 8 is an illustration showing a configuration of a modified example of the IP mobile communication system shown in FIG. 1;

FIG. 9 is an illustration showing a configuration of a modified example of the IP mobile communication system shown in FIG. 1; and

FIG. 10 is an illustration showing a configuration of a modified example of the IP mobile communication system shown in FIG. 1.

### DETAILED DESCRIPTION OF THE INVENTION

Embodiments of the present invention will be described with reference to the accompanying drawings.

FIG. 1 shows a configuration of an IP mobile communication system according to an embodiment of the present invention. The IP mobile communication system comprises SIP clients 100a, 100b, base stations 200a, 200b, mobile communication exchanges 300a, 300b, SIP proxy servers 400a, 400b, and an IP network.

The SIP clients 100a, 100b are mobile telephone terminals, and IP telephone terminals executing communication under VoIP (Voice over Internet Protocol). Each of the mobile communication exchanges 300a, 300b accommodates a plurality of base stations. The SIP client 100a establishes a radio link with the base station 200a and the SIP client 100b establishes a radio link with the base station 200b. Each of the SIP clients 100a, 100b sends an SIP message to or receives an SIP message from the other SIP client via a SIP proxy, by using an IP, and establishes a VoIP session to make communication.

Each of the mobile communication exchanges 300a, 300b accommodates a plurality of base stations as explained above, and manages position information of mobile telephone terminals (SIP clients) in an area covered by the accommodated base stations.

The SIP clients 100a, 100b can execute session monitoring by periodic message sending and reception using timers (RFC4028). In this method, the SIP messages periodically flow between the SIP clients. This message flow is considered to replace the TCP session monitoring in a case where a lower protocol of the SIP is UDP. In this case, a periodic interval is, for example, some tens of seconds to some minutes.

If the SIP client 100a (or 100b) moves out of the service area of the IP mobile communication system (i.e. to a place where communication with the base station cannot be conducted), the base station 200a (or 200b) can rapidly detect the out-of-area movement of the SIP client 100a (or 100b) due to the disconnection of the radio link.

By being notified of the out-of-area movement by the base station 200a (or 200b), the mobile communication exchange 300a (or 300b) can detect that the SIP client 100a (or 100b) is not present within the area covered by the base station 200a (or 200b).

In the present invention, as a method of detecting that the SIP client 100a cannot continue the session due to the out-of-area movement of the SIP client 100b, when the SIP client 100b moves out of the service area, the mobile communication exchange 300b ends the session between the SIP clients 100a and 100b in accordance with the notification of the base station 200b detecting the out-of-area movement of the SIP client 100b. For this reason, the mobile communication exchange 300b sends a BYE message to the SIP client 100a. Thus, the SIP client 100a can rapidly end the session by receiving the BYE message of the corresponding session.

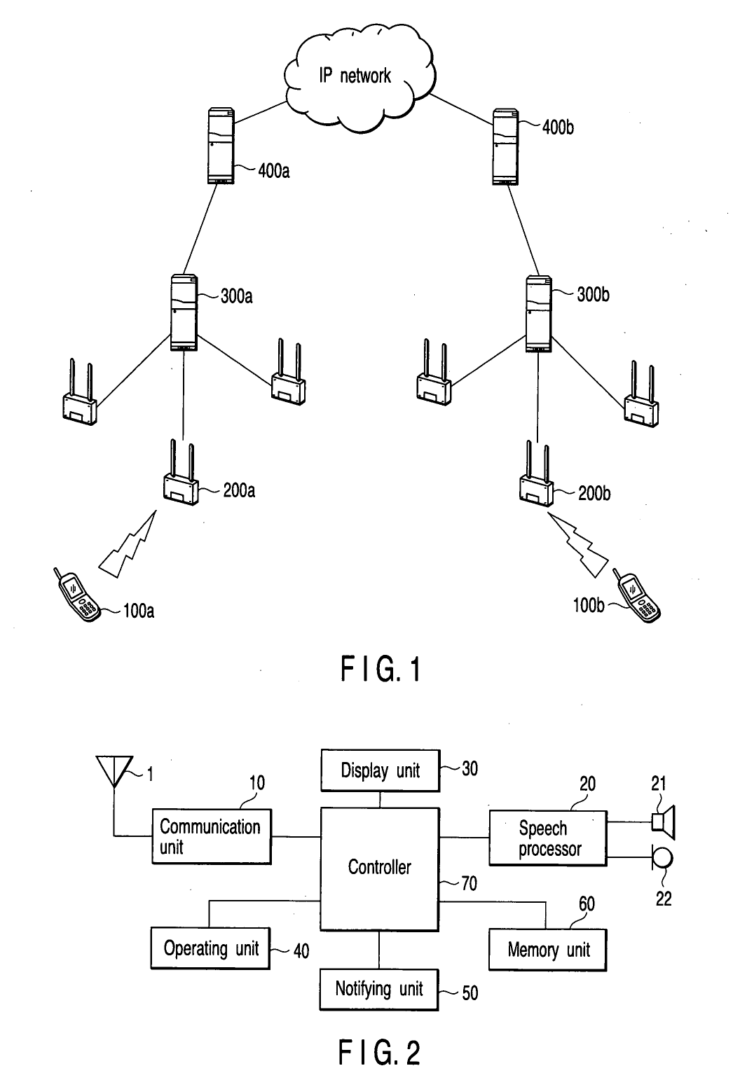

FIG. 2 shows a configuration of the SIP clients 100a, 100b. Each of the SIP clients 100a, 100b comprises an antenna 1, a communication unit 10, a speech processor 20, a display unit 30, an operating unit 40, a notifying unit 50, a memory unit 60, and a controller 70.

The antenna 1 receives radio signals transmitted from the base station 200a or 200b, and transmits radio signals from the SIP client to the base station.

The communication unit 10 executes radio communication with the base station via the antenna 1, and executes IP (Internet Protocol) communication with the partner station (SIP clients 100a, 100b) via the base station. More specifically, the communication unit 10 downconverts and demodulates the radio signal received by the antenna 1, obtains encoded speech data sent from the partner station, and outputs the speech data to the speech processor 20 via the controller 70. In addition, the communication unit 10 modulates the baseband signal with the encoded speech data supplied from the speech processor 20 via the controller 70, generates a radio signal by up-converting the baseband signal, and sends the generated radio signal to the base station via the antenna 1.

The speech processor 20 regenerates a speech signal by decoding the encoded speech data demodulated by the communication unit 10, and outputs the speech signal by a built-in speaker 21. The speech sent from the partner station is thereby transmitted to the user. In addition, the speech processor 20 generates encoded speech data by encoding a speech signal input from a built-in microphone 22, and supplies the generated encoded speech data to the communication unit 10 by the controller 70.

The display unit 30 is a display unit employing an LCD (Liquid Crystal Display), etc., which displays various kinds of visual information such as texts, pictures, etc. to the user. The operating unit 40 comprises a plurality of key switches to accept user's requests. The notifying unit 50 notifies the user of incoming calls by sounds.

The memory unit 60 stores control programs and control data of the controller 70, and telephone directory data associated with telephone numbers, names and picture data such as face pictures, and also stores mail data which have been sent and received, and explanation data related with settings of the SIP client.

The controller 70 controls all the units of the SIP client. For example, the controller 70 comprises an incoming call controlling function of receiving an incoming signal from the base station under SIP (Session Initiation Protocol), controlling the display unit 30 and the notifying unit 50 to notify the user of occurrence of the incoming call, urging the communication unit 10 to transmit a signal responding to the incoming call by a response operation which the user makes by the operating unit 40, and establishing a speech communication link.

The controller 70 also comprises an outgoing call controlling function of controlling the communication unit 10 to make an outgoing call to a telephone number designated by the user, in accordance with the SIP, in response to an outgoing call request which the user makes by the operating unit 40, and a communication controlling function of establishing a speech communication link on the basis of the outgoing call.

In other words, the controller 70 has the controlling functions of implementing the determination of actions, generation of SIP messages, analysis of SIP messages, extraction of data from SIP messages, and sending and reception of SIP messages, in accordance with the SIP.

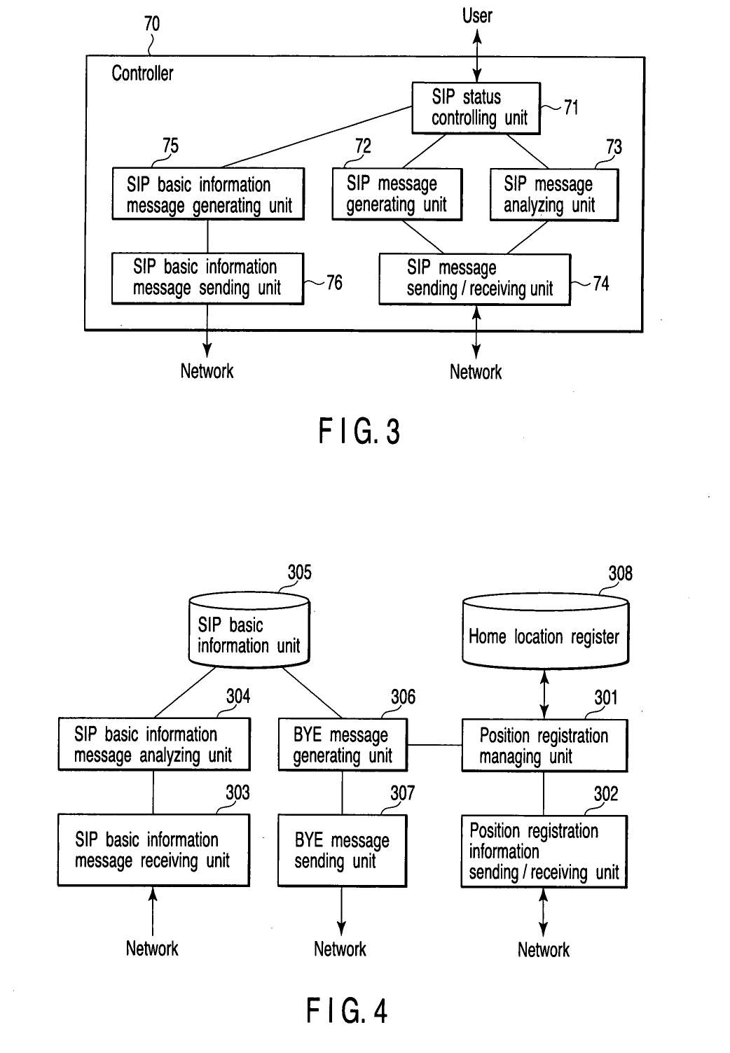

FIG. 3 is a block diagram showing functions of the controller 70. The controller 70 comprises as its functions, an SIP status controlling unit 71, an SIP message generating unit 72, an SIP message analyzing unit 73, an SIP message sending/receiving unit 74, an SIP basic information generating unit 75, and an SIP basic information message sending unit 76.

The SIP status controlling unit 71 manages the status of each unit of the SIP client and determines the action in accordance with the status. If SIP basic information necessary for the mobile communication exchange 300a, 300b to generate BYE message is changed, the SIP status controlling unit 71 outputs the SIP basic information to the SIP basic information generating unit 75.

The SIP message generating unit 72 generates SIP message in accordance with the parameter input from the SIP status controlling unit 71, and outputs the generated SIP message to the SIP message sending/receiving unit 74.

The SIP message analyzing unit 73 analyzes the SIP message input from the SIP message sending/receiving unit 74 and extracts data, and outputs the extracted data to the SIP status controlling unit 71.

The SIP message sending/receiving unit 74 sends the SIP message input from the SIP status controlling unit 71 to a network (base stations 200a, 200b), and outputs the SIP message received from the network to the SIP status controlling unit 71.

When the SIP basic information is input from the SIP status controlling unit 71 to the SIP basic information generating unit 75, the SIP basic information generating unit 75 generates a message for notification of the SIP basic information and outputs the message to the SIP basic information message sending unit 76.

When the SIP basic information message is input from the SIP basic information generating unit 75 to the SIP basic information message sending unit 76, the SIP basic information message sending unit 76 sends the message to the mobile communication exchanges 300a, 300b through the network.

FIG. 4 shows a block diagram of the mobile communication exchanges 300a and 300b. Each of the mobile communication exchanges 300a and 300b comprises a position registration managing unit 301, a position registration information sending/receiving unit 302, an SIP basic information message receiving unit 303, an SIP basic information message analyzing unit 304, an SIP basic information unit 305, a BYE message generating unit 306, a BYE message sending unit 307, and a home location register 308.

The position registration managing unit 301 stores position registration information of the SIP client (100a or 100b) supplied from the position registration information sending/receiving unit 302, in the home location register 308. In the home location register 308, the position registration information is stored in association with each SIP client. If the position registration managing unit 301 can detect from the position registration information that the SIP client has moved out of the service area of the base station connected thereto, the position registration managing unit 301 notifies the BYE message generating unit 306 of a terminal identifier.

The position registration information sending/receiving unit 302 receives the position registration information sent from the SIP client, from the network (base station), and supplies the position registration information to the position registration managing unit 301.

The SIP basic information message receiving unit 303 receives the SIP basic information message sent from the SIP client, from the network, and supplies the received SIP basic information message to the SIP basic information message analyzing unit 304.

The SIP basic information message analyzing unit 304 obtains SIP basic information by analyzing the SIP basic information message input from the SIP basic information message receiving unit 303, and stores the SIP basic information in the SIP basic information unit 305.

The SIP basic information unit 305 stores the SIP basic information of the SIP client.

When the position registration managing unit 301 notifies the BYE message generating unit 306 that the SIP client has moved out of the service area, the BYE message generating unit 306 obtains the SIP basic information of the SIP client from the SIP basic information unit 305 and generates BYE message to be sent to the partner SIP client in the session. In addition, the BYE message generating unit 306 supplies the generated BYE message to the BYE message sending unit 307.

The BYE message sending unit 307 sends the BYE message input from the BYE message generating unit 306, to the partner SIP client of the same session as the SIP client which has moved out of the network.

Next, operations of the IP mobile communication system having the above configuration are described. In the following descriptions, the SIP client 100b moves out of the area of communication with the base station 200b connected thereto and needs to end the session.

When the SIP status controlling unit 71 detects that there are some changes in the SIP basic information, the SIP client 100b notifies SIP basic information message generating unit 75 of new SIP basic information and a terminal identifier of the SIP client 100b. The SIP client 100b preliminarily maintains the terminal identifier in a specific memory area.

The SIP basic information message generating unit 75 notified of the SIP basic information, generates and supplies the SIP basic information message to the SIP basic information message sending unit 76. The SIP basic information message sending unit 76 sends the SIP basic information message supplied from the SIP basic information message generating unit 75 to the mobile communication exchange 300b through the network (base station 200b).

When the SIP basic information message receiving unit 303, in the mobile communication exchange 300b, receives the SIP basic information message sent from the SIP client 100b, the SIP basic information message receiving unit 303 supplies the received SIP basic information message to the SIP basic information message analyzing unit 304.

The SIP basic information message analyzing unit 304 obtains the SIP basic information by analyzing the SIP basic information message, and stores the SIP basic information in the SIP basic information unit 305.

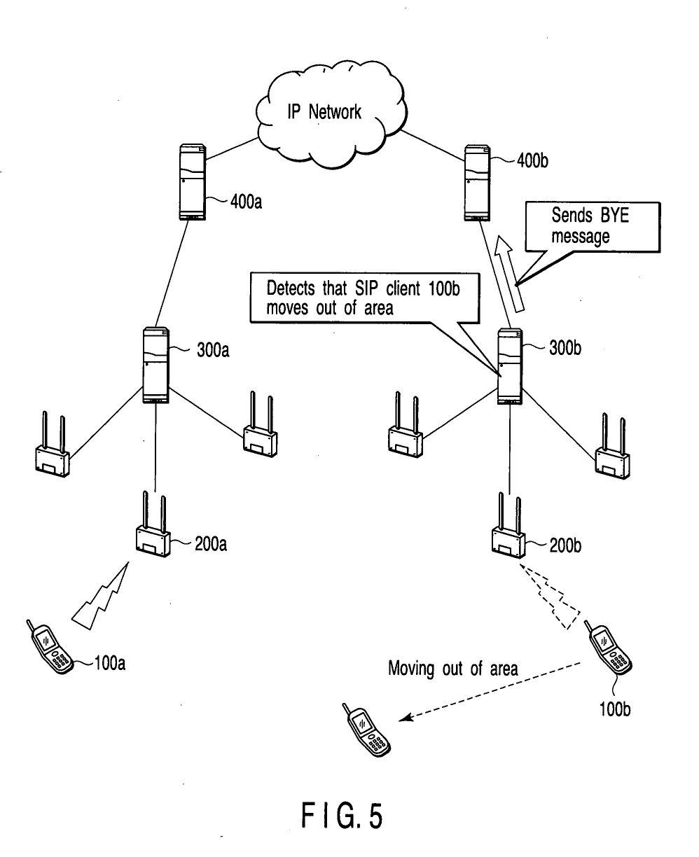

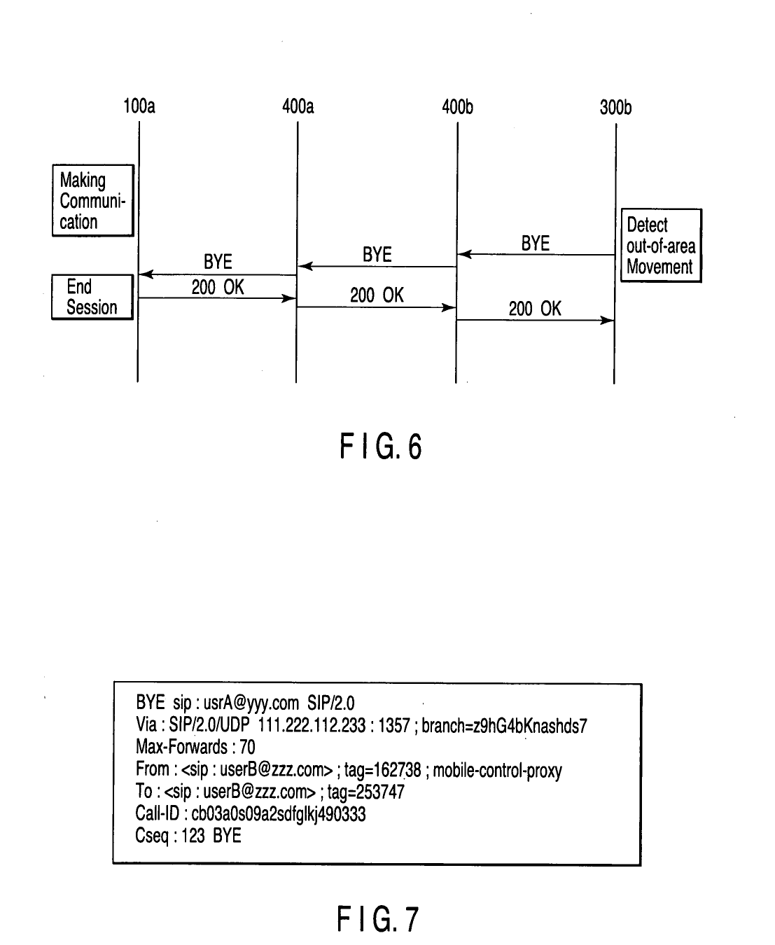

When the SIP client 100b moves out of the area for communication with the base station 200b, as shown in FIG. 5, the mobile communication exchange 300b executes the processing of sending and receiving the message in accordance with a sequence shown in FIG. 6.

First, when the position registration managing unit 301 detects from the change of the position registration information that the SIP client 100b moves out of the communication area, the mobile communication exchange 300b notifies the BYE message generating unit 306 of the terminal identifier of the SIP client 100b.

Then, the BYE message generating unit 306 discriminates whether the SIP basic information of the session of the corresponding SIP client, by using the terminal identifier as a key. If the SIP basic information is stored therein, the BYE message generating unit 306 obtains the SIP basic information. The SIP basic information is deleted in the SIP basic information unit 305.

Then, the BYE message generating unit 306 generates the BYE message on the basis of the SIP basic information obtained from the SIP basic information unit 305, and supplies the generated BYE message to the BYE message sending unit 307.

The BYE message sending unit 307 sends the BYE message supplied from the BYE message generating unit 306, to the SIP client 100a, via the network (SIP proxy server 400b, IP network, SIP proxy server 400a, mobile communication exchange 300a and base station 200a).

When the SIP client 100a receives the BYE message from the mobile communication exchange 300b, the SIP client 100a sends 2000K message (BYE response message) representing acceptance of the BYE message for the mobile communication exchange 300b in the network and ends the session.

The SIP basic information message receiving unit 303 in the mobile communication exchange 300b receives the BYE response message from the network, but abandons the BYE response message and ends the processing.

FIG. 7 shows an example of the BYE message used in the sequence. Since the mobile communication exchange 300b needs to preliminarily maintain information necessary to generate the BYE message, the information necessary to generate SIP header fields To, From, Call-ID, Cseq, Via, Max-Forwards shown in FIG. 7 is regarded as the SIP basic information. Every time the session status changes, the SIP client 100b notifies the mobile communication exchange 300b of the SIP basic information.

In the IP mobile communication system having the above configuration, when the mobile communication exchange 300b detects that the SIP client 100b has moved out of the area of communication with the base station 200b, the mobile communication exchange 300b generates the BYE message, sends the generated BYE message to the SIP client 100a and ends the session.

Therefore, if one of two terminals in communication with each other moves out of the communication area, the session can be rapidly cut off and the time to maintain the unnecessary session can be reduced.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

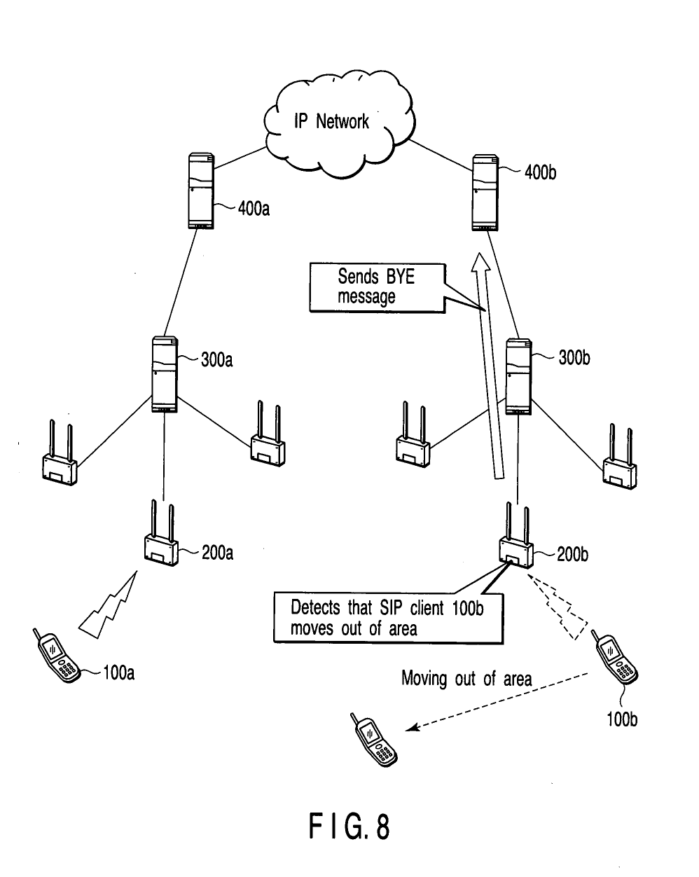

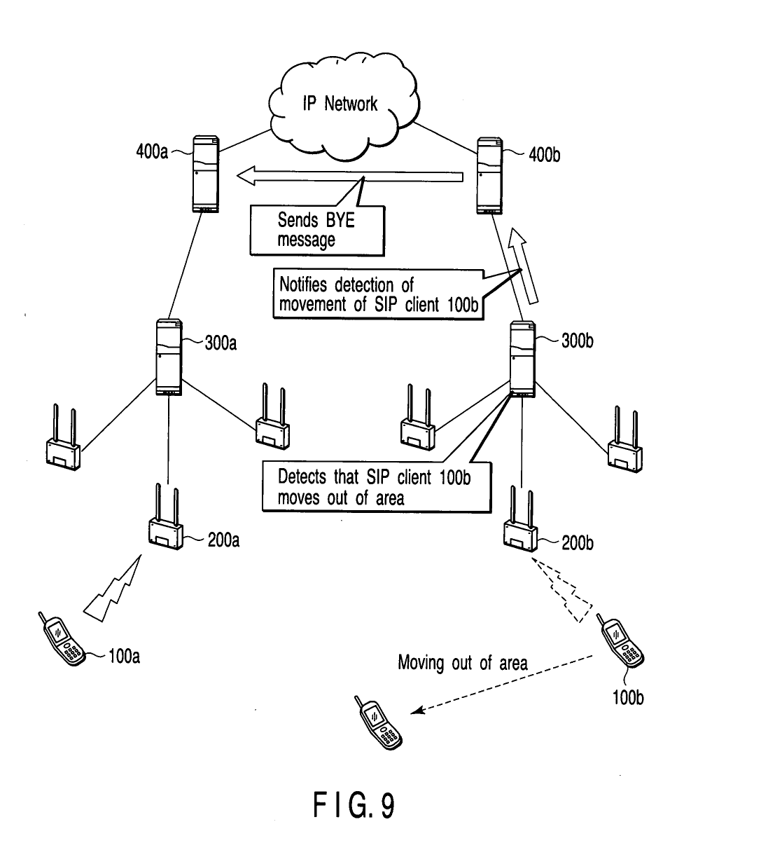

For example, in the above embodiment, the mobile communication exchange 300b comprises the SIP basic information managing function, out-of-area detecting function and the BYE message sending function. Instead of this, however, the base station 200b may comprise these functions as shown in FIG. 8 or the SIP proxy server 400b may comprise some of the functions as shown in FIG. 9.

In the configuration shown in FIG. 9, however, SIP proxy server 400b does not comprise the function of detecting the out-of-area movement of the SIP client 100b. Therefore, the mobile communication exchange 300b or base station 200b detect the out-of-area movement of the SIP client 100b and notifies the SIP proxy server 400b of the detection.

Incidentally, since the detection of the out-of-area movement of the SIP client 100b is to detect the movement out of the area covered by the base station connected to the SIP client 100b, movement to a radio zone of a base station accommodated in the other mobile communication exchange (handover) cannot be detected.

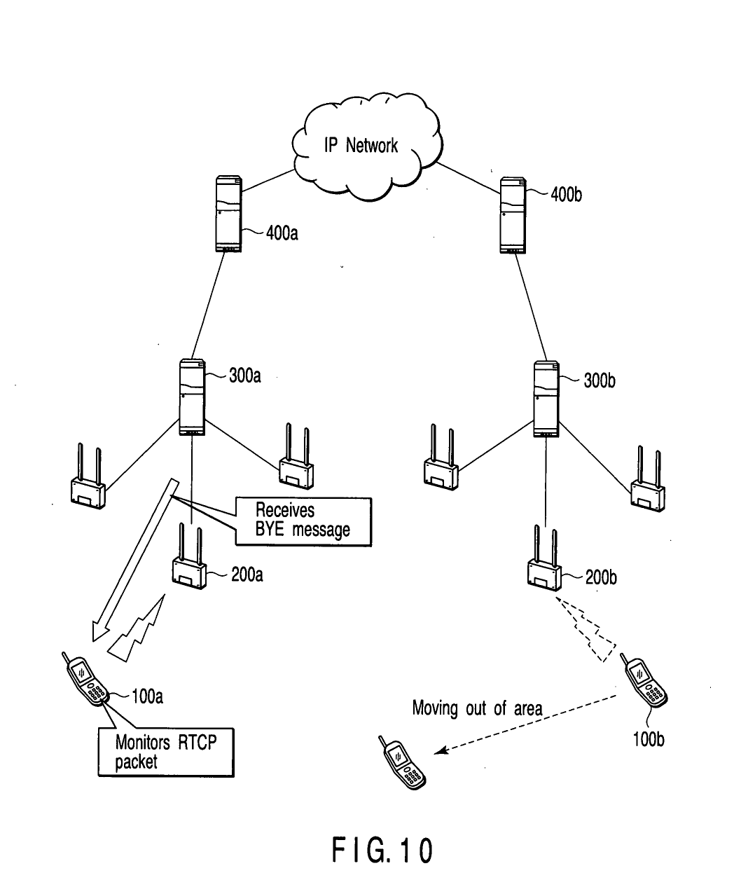

Thus, the SIP client 100a which is notified of the BYE message confirms the mobile communication exchange as the sender from the BYE message, and if the sender is the mobile communication exchange 300b, the SIP client 100a monitors RTCP packets and confirms that the session is cut off, as shown in FIG. 10.

The SIP client 100a receives the BYE message shown in FIG. 7 from the mobile communication exchange 300b. If the mobile communication exchange 300b adds parameter “mobile-control-proxy” to, for example, “From” header field, the SIP client 100a can recognize the mobile communication exchange 300b as the sender of the message.

The “mobile-control-proxy” is newly defined in this invention.

Then, the SIP client 100a monitors the receiving condition of RTCP packets (SDES+SR). It is recommended by the RFC that the RTCP packets should be sent at intervals of some seconds. If the RTCP packets are cut off at a speed (for example, some seconds) at which the handover between the mobile communication exchanges or between the base stations cannot be recognized, the SIP client 100a can control the operations of the display unit 30 and the notifying unit 50 and can urge the user to cut off the session by emitting beep tones.

Needless to say, the present invention can also be variously modified within a scope which does not depart from the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit of scope of the general inventive concept as defined by the appended claims and their equivalents.

What is claimed is:

1. A base station connected to an exchange apparatus and connectable to a client terminal, comprising:
a detector configured to detect that the client terminal cannot make radio connection with the base station; and
a notifying unit configured to transmit a disconnection request to the exchange apparatus if the detector detects that the client terminal cannot make radio connection with the base station.

2. The base station according to claim 1, wherein the detector detects that the client terminal cannot make radio connection with the base station, by monitoring position registration information sent from the client terminal.

3. A base station connected to an exchange apparatus and connectable to a client terminal, comprising:
a detector configured to detect that the client terminal is located outside service area; and
a notifying unit configured to transmit a disconnection request to the exchange apparatus if the detector detects that the client terminal locates outside of the service area.

4. The base station according to claim 3, wherein the detector detects that the client terminal is located outside the service area, by monitoring position registration information sent from the client terminal.

5. An IP mobile communication system including client terminals, base stations, and exchanging apparatuses, wherein two client terminals communicate via the base stations and the exchanging apparatuses,
the base station including
a detector configured to detect that a first client terminal is located outside a service area; and
a notifying unit configured to transmit a disconnection request, via the exchanging apparatus, to a second client terminal if the detector detects that the first client terminal is located outside the service area.

6. The system according to claim 5, wherein the detector detects that the first client terminal is located outside the service area, by monitoring position registration information sent from the client terminal.

7. The system according to claim 5, wherein the second client terminal comprises a receiver configured to receive a disconnection request via the exchanging apparatus, and a session controller disconnects the session with the first client terminal if the receiver does not receive packet data from the first client terminal within a preset period after receiving the disconnection request.

8. The system according to claim 5, wherein the exchanging apparatus accommodates a plurality of base stations and manages position information of the client terminals, and a proxy server connecting the exchanging apparatus with the IP network.
